(19) United States
(12) Patent Application Publication
(10) Pub. No.: US 2003/0187613 A1
(43) Pub. Date: Oct. 2, 2003

(54) Method of data interpolation using midpoint slope control scaling

(76) Inventor: Kun-Nan Cheng, Hsinchu (TW)

Correspondence Address: J.C. Patents, Inc., 4 Venture, Suite 250, Irvine, CA, 92618, US

(21) Appl. No.: 10/371,762

(22) Filed: Feb. 21, 2003

Related U.S. Application Data
(60) Provisional application No. 60/369,521, filed on Apr. 1, 2002.

(51) Int. Cl. G06F 17/18

(52) U.S. Cl. 702/179

(57) ABSTRACT

The present invention provides a method of up and down scaling of a source data to generate a destination data. With three source points as references, each piece of destination data can be generated. A slope control is used to control the sharpness of the interpolation result. The interpolation curve passes through the midpoint of two neighbor pixels with a slope defined at the first midpoint and then passes through the second midpoint of next two neighbor pixels. It is not necessary for the interpolation curve to pass the source sample points. By doing this, a uniform scaling result can be achieved. Also, a Z transformation method can be used for further reducing the computing complexity and cost. The present invention has especially good scaling quality in scaling down case. Prior methods require more reference points and therefore storage, and higher cost for achieving similar functionality

### CROSS-REFERENCE TO RELATED APPLICATION

This application claims the priority benefit of U.S. provisional application titled “MIDDLE POINT SLOPE CONTROL SCALING (MPSC) BACKGROUND OF THE INVENTION” filed on Apr. 1, 2002, serial No. 60/369,521.

### BACKGROUND OF THE INVENTION

1. Field of the Invention

The present invention relates to a method of data interpolation, and more particularly to a method of data interpolation using midpoint slope control scaling to scale up or down of different types of data.

### DESCRIPTION OF RELATED ART

Scaling is useful in graphics, image, video or audio applications for expanding or shrinking sample resolution and for zooming. Especially in a digital display device with a fixed resolution, different kinds of source image formats must be scaled to fit the resolution of the digital display device.

For example, a display panel may have a fixed resolution of 1024×768 pixels in a XGA mode, but the source image may come from computer, video decoder, or others that the input resolution varies depending on the input modes. The input source in a VGA mode (640×480 pixels) with a resolution less than that of the display mode XGA needs to be scaled up when displayed on the XGA panel. On the other hand, an input source in a SXGA mode (1280×1024 pixels) with a resolution greater than that of the display mode XGA needs to be scaled down when displayed on the XGA panel. Image resizing is very important for digital display devices such as liquid crystal device (LCD). Prior art provides different well-known methods such as Bilinear, Cubic, B-Spline, Besier to achieve a good filtering effect for scaling purposes.

The Bilinear method is the most commonly used method of interpolation with low cost. It benefits in its simplicity, speed, and cost because only two reference points are taken. As a result, the cost of the implementation of the Bilinear method is low because computation and storage requirements are less compared to other high-order interpolation methods. However the output of the Bilinear method is blurry due to lack of sharpness from the interpolation results and therefore is not suitable for text images. The sharpness of the picture quality depends on curves after fitting the interpolation points. The Bilinear method takes weighting averages as the interpolation result. Consider two neighbor pixels A aand B, if the interpolation point C is located between A and B with distance D (D≦1) from A, then the interpolation result according to the Bilinear method is

C=A(1−D)+BD Eq. 1

Cubic or B-Spline methods are the more preferred methods used in a high quality scaling system with almost perfect scaling quality, but the cost is very high for computation and storage. Cubic methods usually require four points f(-1), f(0), f(1), and f(2) as references. The Cubic Curve using the Hermite Method has a start point P₁, an end point P₂, a start point tangent-vector R₁, and an end point tangent-vector R₂ by the formula

f(x)=(2x³−3x²+1)P₁+(−2x³+3x²)P₂+(x³−2x²+x)R₁+(x³−x²)R₂ Eq. 2

=(2P₁−2P₂+R₁+R₂)x³+(−3P₁+3P₂−2R₁−R₂)x²+R₁x+P₁ Eq. 3

where P₁=f(0),

P₂=f(1)

R₁=G₁(P₂−P₀)/2=G₁[f(1)−f(−1)]/2=tangent-vector at P1

R₂=G₂(P₃−P₁)/2=G₂[f(2)−f(0)]/2=tangent-vector at P2

G₁, G₂ are gain factors, wherein the gain factor is proportional to the sharpness of the scaling result.

The Besier curve is also famous and used in many applications like the curve fitting, 2D boundary, or 3D surface . . . etc. The Besier curve uses four points, P₁, P₂, P₃ and P₄ as control points. It indirectly specifies an endpoint tangent vector by specifying two intermediate points that are not on the curve. The starting and ending tangent vectors are determined by vector P₁P₂ and P₃P₄ and are related to R₁ and R₄ by

R₁=f′(0)=3(P₂−P₁), R₄=f(1)=3(P₄−P₃) Eq. 4

f(x)=(1−x)³P₁+3x(1−x)²P₂+3x²(1−x)P₃+x³P₄ Eq. 5

### SUMMARY OF THE INVENTION

An object of the present invention provides a method of data interpolation to scale up or down of different types of data such as graphics, image pixels, video pixels, and audio, which can be used for analysis, object-moving tracking analysis, finder for object 2D shape or 3D surface in graphics by performing scaling of the source data to the destination data with a midpoint slope control (MPSC) scaling method.

The present invention provides a low cost and high performance MPSC scaling method for both shrinking and zooming purposes by a second order equation. The quality of the MPSC method can be compared with the Cubic or B-Spline methods, while keeping the cost approximately equal to that of the Bilinear method. The MPSC method of the present invention only requires the minimum of three reference points so therefore computation and storage requirement are less than that of Cubic or B-Spline methods and equal to the minimal size of Bilinear method. Each piece of the destination data can be generated only with two neighboring source points and a midpoint between the two source points as reference. A slope control is used to control the sharpness of the interpolation result. The interpolation curve starts from any one of a set of the two neighboring source points. After the interpolation points are located by the first set of 2 neighboring source points, consecutive sets of 2 neighboring points will be taken until all the reference points are used. The slope defining a straight line which passes through the two neighboring points and crossing the midpoint of the two neighboring points is D. Different midpoint point slope gain DG affects the scaling quality, and can be adjusted according to different scaling requirements. Also, a Z transform is alternatively used to further reduce the computing complexity and cost.

It is to be understood that both the foregoing general description and the following detailed description are exemplary, and are intended to provide further explanation of the invention as claimed.

### BRIEF DESCRIPTIOIN OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic diagram illustrating a curve using a midpoint slope control (MPSC) scaling method of a preferred embodiment of the present invention;

FIG. 2 is a schematic diagram illustrating the behavior using the MPSC scaling method with different gains of slopes at the start source point;

FIG. 3 is a schematic diagram illustrating the result of scaling with a scaling factor of 0.75 in an embodiment of the invention;

FIG. 4 is a schematic diagram illustrating the application of the MPSC method of an embodiment of the present invention on a 2D object shape;

FIG. 5 is a schematic diagram of a true-type vector font generated by the MPSC method of an embodiment of the present invention.

### DETAILED DESCRIPTION OF THE PREFERRED EMBODIEMENTS

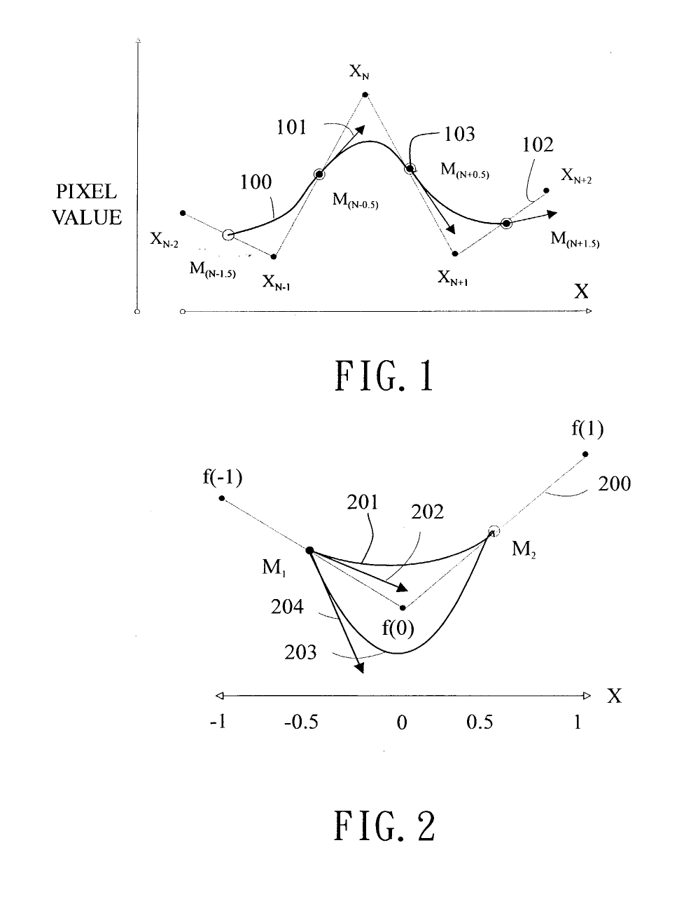

FIG. 1 is a curve using a midpoint slope control (MPSC) scaling method of a preferred embodiment of the present invention. A set of X denotes all of source data in the embodiment, for example, the X_{N-2}, X_{N-1}, X_{N}, X_{N+1}, X_{N+2}, as shown in FIG. 1. An intermediate points M_{(n+0.5)} 103 is a middle point of X_{N} and X_{N+1}, it is not the source data, but a data for further computation. A set of M denotes all of middle points in the embodiment, for example, the middle points M_{(n-1.5)}, M_{(n-0.5)}, M_{(n+0.5)}, and M_{(n+1.5)} as shown in FIG. 1. The curve 102 is the fitting curve by using Bilinear method for comparison reason. The curve 100 is the curve of the result using the MPSC method of the embodiment. The curve 100 passes all of the middle points M, and with a slope 101 at each point of M. It is not necessary for the curve 100 to touch the source data X The theory behind the present invention is as follow:

given f(x)=ax²+bx+c Eq. 6

then f′(x)=2ax+b; Eq. 7

f(−1),f(0),f(1) are the source image reference points, the two middle points that the curve passes are f(−0.5) and f(0.5) respectively with middle point slopes f′(−0.5) and f′(0.5). The middle points f(−0.5) and f(0.5) are not the original reference points, but the intermediate results of f(−1),f(0) and f(1).

Define the following terms:

M₁: a start middle point=f(−0.5)=(f(0)+f(−1))/2 Eq. 8

M₂: an end middle point=f(0.5)=(f/(0)+f(1))/2 Eq. 9

D₁: a start middle point slope=f′(−0.5)=f(0)−f(−1) Eq. 10

D₂: an end middle point slope=f′(0.5)=f(1)−f(0) Eq. 11

Apply initial conditions set (A): use D₁, M₁, M₂

f′(−0.5)=−a+b=D₁, Eq. 12

f(−0.5)=0.25a−0.5b+c=(f(−1)+f(0))/2=M₁ Eq. 13

f(0.5)=0.25a+0.5b+c=(f(0)+f(1))/2=M₂ Eq. 14

or apply initial conditions set (B): use D₂, M₁, M₂

f′(0.5)=a+b=D₂, Eq. 15

f(−0.5)=0.25a−0.5b+c=(f(−1)+f(0))/2=M₁ Eq. 16

f(0.5)=0.25a+0.5b+c=(f(0)+f(1))/2=M₂ Eq. 17

Therefore two solutions in terms of a, b, c are obtained for f(x) and the two solutions will be the same.

f(x)=((f(1)+f(−1)−2f(0))/2)x²+((f/(1)−f(−1))/2)x+((f(1)+6f(0)+f(−1))8) Eq. 18

Typically, a gain factor for the slopes f′(−0.5) or f′(0.5) is applied. i.e.

f′(−0.5)=DG₁=D₁Gain=(f(0)−f(−1))Gain Eq. 19

f′(0.5)=DG₂=D₂Gain=(f(1)−f(0))Gain Eq. 20

Thus the solution will change as

Condition (A):

f(x)=f(1)−f(−1))/2−DG₁)x²+((f(1)−f(−1))/2)x+((f(1)+4f(0)+3f(−1))/8+DG₁/4) Eq. 21

Condition (B):

f(x)=(DG₂−(f(1)−f(−1))/2)x²+((f(1)−f(−1))/2)x+((3f(1)+4f(0)+f(−1))/8−DG₂/4) Eq. 22

The cost estimation of the above method on both sets of condition (A) and (B) are calculated and shown below.

| | Parameter | Adder | Multiplier | Note |
|---|---|---|---|---|
| Condition (A) | DG₁ = (ƒ(0) − ƒ(−1)) G | 1 | 1 | |
| | a = (ƒ(1) − ƒ(−1))/2 −DG₁ | 2 | 0 | |
| | b = (ƒ(1) − ƒ(−1))/2 | 0 | 0 | Share with a |
| | c = (ƒ(1) + 4ƒ(0) + 3ƒ(−1))/8 + DG₁/4 | 4 | 0 | 3ƒ(−1) need 1 adder |
| | Total | 7 | 1 | |
| Condition (B) | DG₂ = (ƒ(1) − ƒ(0)) G | 1 | 1 | |
| | a = DG₂ − (ƒ(1) − ƒ(−1))/2 | 2 | 0 | |
| | b = (ƒ(1) − ƒ(−1))/2 | 0 | 0 | Share with a |
| | c = ((3ƒ(1) + 4ƒ(0) + ƒ(−1)))/8 − DG₂/4 | 4 | 0 | 3ƒ(−1) need 1 adder |
| | Total | 7 | 1 | |

Parameter Adder Multiplier Note Condition (A) DG, =((0) -fl- )) G 1 1 a =(/(I) -J(-1))/ 2- DG 2 0 b=(/(I) -j(-1))/2 0 0 Share with a c=(fl)+4J(0)+3f- 1))/8 +DG₁14 4 0 3J(-1) need I adder Total 7 1 Condition (B) DG₂=(/(I) -J(O)) G 1 1 a=DG₂-(/(I)-f(-1))/ 2 2 0 b=(f(1) -J(-1))/2 0 0 Share with a c=((3f1)+4f10)+fl-1)))/8 - DG₂14 4 0 3f(- 1) need 1 adder Total 7 1

Please refer to the table above, the cost is high with seven adders and therefore coordinate transformation is induced to reduce the cost.

Apply a Z transformation method, which has the relationship with X coordinate as follows:

F(z)=az²+bz+c Eq. 23

F′(z)=2az+b; Eq. 24

Condition (A)

Z(z)=X(x)+0.5 Eq. 25

i.e.

Z(0)=X(−0.5) Eq. 26

Z(0.5)=X(0) Eq. 27

Z(1)=X(0.5) Eq. 28

Initial conditions: D₁, M₁, M₂, and a gain factor G

F′(0)=b=DG₁=(f(0)−f(−1))G, Eq. 29

F(0)=c=(f(−1)+f(0))/2=M₁ Eq. 30

F(1)=a+b+c=(f(0)+f(1))/2=M₂ Eq. 31

Thus

F(z)=((f(1)−f(−1))/2−DG₁)z²+(DG₁)z+((f(−1)+f(0))/2) Eq. 32

Condition (B)

Z(z)=X(x)−0.5 Eq. 33

i.e.

Z(−1)=X(−0.5) Eq. 34

Z(−0.5)=X(0) Eq. 35

Z(0)=X(0.5) Eq. 36

initial conditions: D₂, M₁, M₂, and a gain factor G

F′(0)=b=DG₂=(f(1)−f(0))G, Eq. 37

F(0)=c=(f(1)+f(0))/2=M₂ Eq. 38

F(−1)=a−b+c=(f(0)+f(−1))/2=M₁ Eq. 39

thus

F(z)=((f(−1)−f(1))/2+DG₂)z²+(DG₂)z+((f(+1)+f(0))/2) Eq. 40

The cost estimation for employing the Z transformation method:

| | Parameter | Adder | Multiplier | Note |
|---|---|---|---|---|
| Condition (A) | DG₁ = (ƒ(0) − ƒ(−1)) G | 1 | 1 | |
| | a = (ƒ(1) − ƒ(−1))/2 − DG₁ | 2 | 0 | |
| | b = DG₁ | 0 | 0 | Share |
| | | | | with |
| | | | | DG₁ |
| | c = (ƒ(−1) + ƒ(0))/2 | 1 | 0 | |
| | Total | 4 | 1 | |
| Condition (B) | DG₂ = (ƒ(1) − ƒ(0)) G | 1 | 1 | |
| | a = (ƒ(−1) − ƒ(1))/2 + DG₂ | 2 | 0 | |
| | b = DG₂ | 0 | 0 | Share |
| | | | | with |
| | | | | DC₂ |
| | c = (ƒ(1) + ƒ(0))/2 | 1 | 0 | |
| | Total | 4 | 1 | |

Parameter Adder Multiplier Note Condition (A) DG, =( (O) -A(- i)) G 1 I a=(/(I)-fl-1))/2-DG, 2 0 b=DGI 0 0 Share with DG, c=(fl-1)+flO))/2 1 0 Total 4 1 Condition (B) DG₂=(/(I) -J(0)) G 1 1 a=(/(-l)-J(1))/2+DG₂ 2 0 b=DG₂ 0 0 Share with DG₂ c=(J(I)+J(O))/2 1 0 Total 4 I

By applying a simple Z transformation method on the equation, the number of adders is brought down to four from its original seven. However due to the fact that true color requires three separate R,G,B channels in a display system, this means three sets of J(x) are needed. Since x denotes the position, the three sets are identical so only one set offjx) will be discussed. The transformation for conditions (A) and (B) are just bit mapping because 0.5 is a suitable value for implementation. For example, a binary code 00000 denotes 0, a binary code 10000 denotes 0.5, a binary code 01000 denotes 0.25, and a binary code 11000 denotes 0.75, etc. . . . This means that some bit mapping can solve the transformation, which at most needs just half of the number of the adders compared with that without using the Z transformation method.

Thus, the MPSC Scaling method using the Z transformation method can be reduced the number of the adders from seven to four for calculation of the parameters a, b and c. If the multiplier is implemented with a shifter (i.e. 4×, 2×, 1×, 0.5×, 0.25×), the cost will totally locate on the number of the adders. This will enhance the importance of the Z transformation method, which reduces the number of the adders from seven to four.

FIG. 2 is a behavior of the MPSC scaling method with different gains of the slopes at the start middle point of the preferred embodiment of the present invention. The curve 200 is the fitting curve by using Bilinear method for comparison reason. f(−1), f(0) and f(1) are the source points. M₁ and M₂ are the middle points of f(−1), f(0) and f(0), f(1), it is not the source data, but a data for computation. The curve 201 denotes the curve using present invention MPSC method between the middle point M₁ and M₂ with a slope 202 at the middle point M₁. The curve 203 denotes the curve using the MPSC method between the middle point M₁ and M₂with a slope 204 at the middle point M₁. The slope at the middle point affects the curve of the MPSC method, as shown in FIG. 2, the slope 204 with a greater G than that of slope 202. If G≦1, it is good for a shrink case to get an even and smooth decimation result, and the curve 201 is desired. Otherwise, G>1 is good for a scaling up case to get a sharp result, and the curve 203 is desired. The gain factor G is important for shrinking and scaling. If G<1, it is good for shrink case to get an even and smooth decimation result. Otherwise, G>1 is good for scaling up case to get a sharp result.

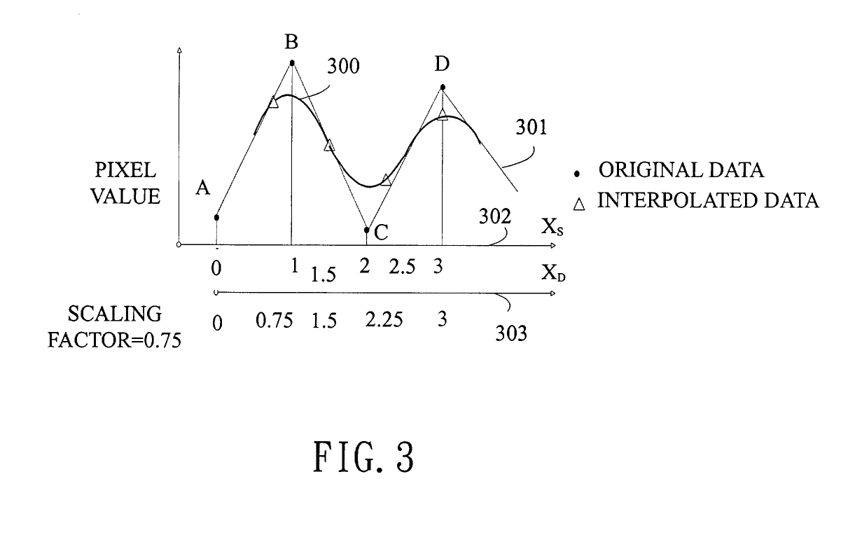

FIG. 3 shows an implementation using the MPSC method of the preferred embodiment. A curve 300 is the curve using the MPSC method and a curve 301 is the Bilinear curve. X_{S} 302 is a coordinate for source data locations, and X_{D} 303 is a coordinate for destination interpolation data locations. For zoom and shrink purposes, the procedure is as follow:

a. X_{S} denotes a position coordinate with original data D₀, D₁, D₂, D₃ . . . D_{M} where x=0,1,2,3, . . . , M, M is an integer;

b. A scaling factor generator generates the interpolation location X_{D}. The scaling factor is decided by (input resolution)/(output resolution), and 0.75 is used in this embodiment. Scaling factor <1 represents up scaling and scaling factor >1 represents down scaling.

c. Interpolation points x are located between the coordinate x=N−0.5 to x=N+0.5.

given

f(−1)=D_{N-1}

f(0)=D_{N}

f(1)=D_{N+1}

and x=−0.5 . . . 0.5 (truncate the integer part N)

d. Apply a Z transformation method, where Z(z)=X(x)+0.5 for condition (A),

F(z)=((f(1)−f(−1))/2−DG₁)z²+(DG₁)z+((f(−1)+f(0))/2) Eq. 41

for a range x=−0.5 . . . 0.5 change to z=0 . . . 1

or apply a Z transformation method, where Z(z)=X(x)−0.5 for condition (B),

F(z)=((f(−1)−f(−1))/2+DG₂)z²+(DG₂)z+((f(+1)+f(0))/2) Eq. 42

for the range x=−0.5 . . . 0.5 change to z=−1 . . . 0

e. Calculate the F(z) which denotes the data after scaling or shrinking at point x.

The MPSC method is good for zooming and shrinking in graphic, image, video or audio, and furthermore also suitable for application of polygon curve fitting in many area such as object moving tracking analysis, data analysis, finder for object 2D shape or 3D surface in graphic area, or true type vector font.

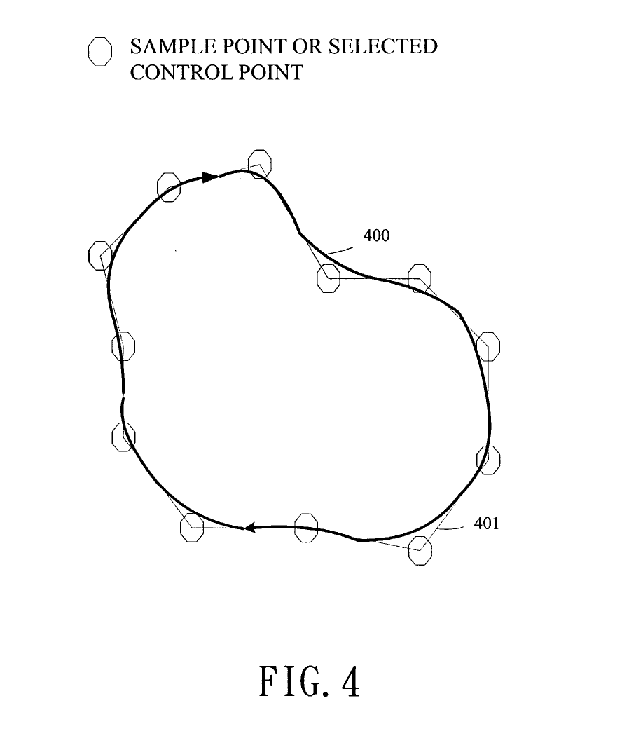

FIG. 4 is an application of a single slope used in the MPSC method of present invention on a 2D object shape. The outline of any 2D shape object can be obtained by connecting all the reference source points together. The sample point and selected shape control points form the curve 400, which is the boundary of a 2D shape object using the MPSC method.

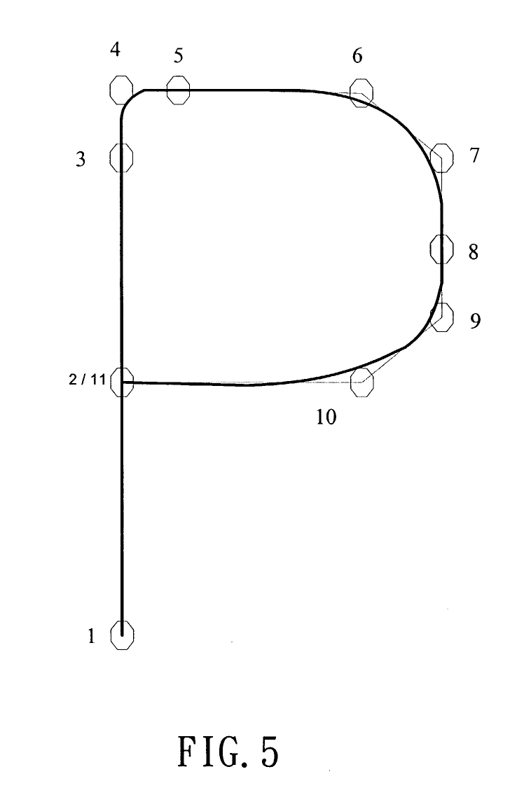

FIG. 5 shows a true type vector font generated using the MPSC method of present invention. The MPSC curve is smooth yet crisp which is very suitable for the engine of true type vector font which using some characteristic points to represent the font. The points label 1,2,3, . . . ,11 represent the render order using MPSC method. The font “P” can be generated by the 11 sample points according to the MPSC method for example. If font scaling is required, only the location of sample points after the scaling are needed to be changed and maintained. The outline shape will be generated by the MPSC method.

The MPSC scaling method of the present invention is low cost and high performance in scaling compared to the well-known method Cubic or B-Spline method. By defining the start middle point slope and gain DG, the scaling quality can be controlled and adjusted. The computation, processing, and storage requirement are only a little greater than that of Bilinear method but considerably less than that of Cubic or B-Spline methods because MPSC scaling method only requires 3 reference points. Furthermore a sharper and crispier image is achieved in scaling up a source image as compared to the blurry image output using the Bilinear method. It is very important during vertical scaling that the whole line of image data must stored as a whole in the line buffer. The present invention is excellent in many applications like in scaling of graphic, image, video, audio, or polygon curve fitting applications, moving tracking analysis, data analysis, or finder for object 2D shape or 3D surface in graphic area.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of interpolating data for scaling a source data to a destination data, the method comprising:
receiving an the source data from an input curve f(x);
selecting three of reference points from the received source data;
finding a start midpoint and an end midpoint from the three reference points;
calculating a slope of the start midpoint and applying a gain factor to the slope of the start midpoint;
finding a solution to the input curve f(x) in terms of the three reference points and the gain factor;
using the solution to calculate and generate a plurality of interpolation points based on a scaling factor; and
fitting the input curve f(x) with the interpolation points.

2. The method of claim 1, wherein the step of finding the solution further comprising applying a Z-transformation method to the solution.

3. The method of claim 1 further comprising applying initial conditions to the input curve f(x) for the start midpoint, the end midpoint and the slope of the start midpoint.

4. The method of claim 1, wherein if the value of the gain factor is larger than 1, the method for interpolating data is used for scaling up the source data to the destination data.

5. The method of claim 1, wherein if the value of the gain factor is smaller than 1, the method for interpolating data is used for shrinking the source data to the destination data.

6. A method of interpolating data for scaling a source data to a destination data, the method comprising:
receiving the source data from an input curve f(x);
selecting three reference points f(−1), f(0) and f(1) from the source data;
finding a start midpoint f(−0.5) between the reference points f(−1) and f(0);
calculating a slope of the midpoint f(−0.5) and applying a gain factor by an equation:
f′(−0.5)=DG₁=(f(0)−f(−1)),
wherein G₁ is the gain factor and D is the midpoint slope;
finding a solution to the input curve f(x) by equations:
f′(x)=((f(1)−f(−1))/2−DG₁)x²+((f(1)−f(1))/2)x+((f(1)+4f(0)+3j(−1))8+DG₁/4);
using the solution to calculate and generate a plurality of interpolation points based on a scaling factor; and
fitting the input curve f(x) with the interpolation points.

7. The method of claim 6 further comprising applying initial conditions to the input curve f(x) for the three reference points with equations:
M₁: the start middle point=f(−0.5)=(f(0)+f(−1))/2,
M₂: an end middle point=f(0.5)=(f(0)+f(1))/2,
f′(−0.5)=DG₁=(f(0)−f(−1))G₁.

8. The method of claim 6, wherein if the value of the gain factor is larger than 1, the method for interpolating data is used for scaling up the source data to the destination data.

9. The method of claim 6, wherein if the value of the gain factor is smaller than 1, the method for interpolating data is used for shrinking the source data to the destination data.

10. A method of interpolating data for scaling a source data to a destination data, the method comprising:
receiving the source data from an input curve f(x);
selecting three reference points f(−1), f(0) and f(1) from the source data;
finding a start midpoint f(0.5) between the two reference points f(−1) and f(0);
calculating a slope of the start midpoint f(0.5) and applying a gain factor by an equation:
f′(0.5)=DG₂=(f(1)−f(0)),
wherein G₂ is the gain factor and D is the midpoint slope;
finding a solution to the input curve f(x) by equations:
f(x)=(DG₂−(f(1)−f(−1))/2)x²+((f(1)−f(−1))/2)x+((3f(1)+4f(0)+f(−1))/8−DG₂/4);
using the solution to calculate and generate a plurality of interpolation points based on a scaling factor; and
fitting the input curve f(x) with the interpolation points.

11. The method of claim 10 further comprising applying initial conditions to the input curve f(x) for the three reference points with equations:
M₁=the start middle point=f(−0.5)=(f(0)+f(−1))/2,
M₂: an end middle point=f(0.5)=(f(0)+f(1))/2,
f′(0.5)=DG₂=(f(1)−f(0))Gain,
wherein D is the midpoint slope, and G₂ is the gain factor.

12. The method of claim 10, wherein if the value of the gain factor is larger than 1, the method for interpolating data is used for scaling up the source data to the destination data.

13. The method of claim 10, wherein if the value of the gain factor is smaller than 1, the method for interpolating data is used for shrinking the source data to the destination data.

14. A method of interpolating data for scaling a source data to a destination data, the method comprising:
receiving the source data from an input curve f(x);
selecting three reference points f(−1), f(0) and f(1) from the source data;
finding a start midpoint f(−0.5) between the two reference points f(−1) and f(0);
calculating a slope of the start midpoint f(−0.5) and applying a gain factor by an equation:
f′(−0.5)=DG₁(f(0)−f(−1)),
wherein G₁ is the gain factor and D is the midpoint slope;
finding a solution to the input curve f(x) from applying a Z-transformation method suing Z(z)=X(x)+0.5 by equations:
F(z)=((f(1)−f(−1))/2−DG₁)z²+(DG₁)z+((f(−1)+f(0))/2);
using the solution of the Z-transformation to calculate and generate a plurality of interpolation points based on a scaling factor; and
fitting the input curve F(z) with the interpolation points.

15. The method of claim 14 further comprising applying initial conditions to the input curve f(z) for the three reference points with equations:
M₁: the start middle point=f(−0.5)=(f(0)+f(−1))/2,
M₂: an end middle point=f(0.5)=(f(0)+f(1))/2,
f′(−0.5)=DG₁=(f(0)−f(−1))G₁.

16. The method of claim 14, wherein if the value of the gain factor is larger than 1, the method for interpolating data is used for scaling up the source data to the destination data.

17. The method of claim 14, wherein if the value of the gain factor is smaller than 1, the method for interpolating data is used for shrinking the source data to the destination data.

18. A method of interpolating data for scaling a source data to a destination data, the method comprising:
receiving the source data from an input curve f(x);
selecting three the reference points f(−1), f(0) and f(1) from the source data;
finding a start midpoint f(0.5) between the two reference points f(−1) and f(0);
calculating a slope of the start midpoint f(0.5) and applying a gain factor by an equation:
f′(0.5)=DG₁=(f(1)−f(0)),
wherein G₁ is the gain factor and D is the midpoint slope;
finding a solution to the input curve f(x) from applying a Z-transformation Z(z)=X(x)+0.5 by equations:
F(z)=((f(−1)−(1))/2+DG₂)z²+(DG₂)z+((f(+1)+f(0))/2),
wherein G₁ is the gain factor and D is the midpoint slope;
using the solution of the Z-transformation to calculate and generate a plurality of interpolation points based on a scaling factor; and
fitting the input curve F(z) with the interpolation points.

19. The method of claim 18 further comprising applying initial conditions to the input curve f(z) for the three reference points with equations:
M₁: the start middle point=f(−0.5)=(f(0)+f(−1))/2,
M₂: an end middle point=f(0.5)=(f(0)+f(1))/2,
f′(0.5)=DG₁(f(1)−f(0))G₁,
wherein D is the midpoint slope, and G₁ is the gain factor, and Z(z)=X(x)−0.5.

20. The method of claim 18, wherein if the value of the gain factor is larger than 1, the method for interpolating data is used for scaling up the source data to the destination data.

21. The method of claim 18, wherein if the value of the gain factor is smaller than 1, the method for interpolating data is used for shrinking the source data to the destination data.

22. A method of interpolating data for scaling a source data to a destination data, where f(−1), f(0) and f(1) are reference points and f′(−0.5)=DG₁=(f(0)−f(−1))G₁ is a slope of a start middle point of the reference points f(−1) and f(0), wherein G₁ is a gain factor and D is the slope of the start midpoint, the method comprising:
applying the gain factor to the calculated slope of the start midpoint;
finding a solution to an input curve f(x) with equations:
f(x)=((f(1)−f(−1))/2−DG₁)x²+((f(1)−f(−1))/2)x+((f(1)+4f(0)+3f(−1))/8+DG₁/4); and
using the solution to calculate and generate a plurality of interpolation points based on a scaling factor.

23. A method of interpolating data for scaling a source data to a destination data, where f(−1), f(0) and f(1) are reference points and f′(0.5)=DG₂(f(1)−f(0))G₂ is a slope of an end middle point of the reference points f(0) and f(1), wherein G₂ is a gain factor and D is the slope of a start midpoint of the reference points f(−1) and f(0), the method comprising:
applying the gain factor to the calculated slope of the end middle point;
finding a solution to an input curve f(x) with equations:
f(x)=(DG₂−(f(1)−f(−1))/2)x²+((f(1)−f(−1))/2)x+((3f(1)+4f(0)+f(−1))/8−DG₂/4); and
using the solution to calculate and generate a plurality of interpolation points based on a scaling factor.

24. A method of interpolating data for scaling a source data to a destination data, where f(−1), f(0) and f(1) are reference points and f′(−0.5)=DG₁=(f(0)−f(−1))Gain is a slope of a start middle point of the reference points f(−1) and f(0), wherein G₁ is a gain factor and D is the slope of the start middle point, the method comprising:
applying the gain factor to the calculated slope of the start middle point;
finding a solution to an input curve f(x) by Z transformation Z(z)=X(x)+0.5 with equations:
F(z)=((f(1)−f(−1))/2−DG₁)z²+(DG₁)z+((f(−1)+f(0))/2);and
using the solution to calculate and generate a plurality of interpolation points based on a scaling factor.

25. A method of interpolating data for scaling a source data to a destination data, where f(−1), f(0) and f(1) are reference points and f′(0.5)=DG₂=(f(1)−f(0))Gain is a slope of an end middle point of the reference points f(0) and f(1), wherein G₂ is a gain factor and D is a slope of a start middle point of the reference points f(−1) and f(0), the method comprising:
applying the gain factor to the calculated slope of the end middle point;
finding a solution to an input curve f(x) by Z transformation Z(z)=X(x)−0.5 with equations:
F(z)=((f(−1)−f(1))/2+DG₂)z²+(DG₂)z+((f(+1)+f(0)/2);and
using the solution to calculate and generate a plurality of interpolation points based on a scaling factor.
